(19) United States
(12) Patent Application Publication
(10) Pub. No.: US 2020/0214227 A1
(43) Pub. Date: Jul. 9, 2020

(54) MODULAR PLANT CAGE ASSEMBLY

(71) Applicant: Stephen Szwabowski, Inkster, MI (US)

(72) Inventor: Stephen Szwabowski, Inkster, MI (US)

(21) Appl. No.: 16/239,016

(22) Filed: Jan. 3, 2019

(51) Int. Cl. A01G 9/12; F16B 2/22; F16B 7/00

(52) U.S. Cl. CPC A01G 9/12; F16B 7/00; F16B 2/22

(57) ABSTRACT

A modular plant cage assembly for supporting a plant during all stages of growth includes a plurality of horizontal members that is each curved along a longitudinal axis such that each of the horizontal members defines an arc of a circular segment. A plurality of vertical supports is each removably coupled between the horizontal members. Thus, each of the vertical and horizontal members forms a cage for positioning around a plant growing in the ground. The vertical supports are stackable in a vertical orientation for adjusting a height of the cage to accommodate all growth stages of the plant. A plurality of stakes is each of the stakes is releasably coupled to one of the horizontal members that is positioned at the bottom of the cage. Each of the stakes penetrates ground such that the cage is spaced above the ground.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to modular cage devices and more particularly pertains to a new modular cage device for supporting a plant during all stages of growth.

### BRIEF SUMMARY OF THE INVENTION

An embodiment of the disclosure meets the needs presented above by generally comprising a plurality of horizontal members that is each curved along a longitudinal axis such that each of the horizontal members defines an arc of a circular segment. A plurality of vertical supports is each removably coupled between the horizontal members. Thus, each of the vertical and horizontal members forms a cage for positioning around a plant growing in the ground. The vertical supports are stackable in a vertical orientation for adjusting a height of the cage to accommodate all growth stages of the plant. A plurality of stakes is each of the stakes is releasably coupled to one of the horizontal members that is positioned at the bottom of the cage. Each of the stakes penetrates ground such that the cage is spaced above the ground.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of a cage defined by a modular plant cage assembly according to an embodiment of the disclosure.

FIG. 2 is a bottom view of a cage of an embodiment of the disclosure.

FIG. 3 is a front view of a cage of an embodiment of the disclosure.

FIG. 4 is a perspective view of a plurality of sets of horizontal members of an embodiment of the disclosure.

FIG. 5 is an exploded perspective view of a pair of vertical members and a plug of an embodiment of the disclosure.

FIG. 6 is a phantom perspective view of an embodiment of the disclosure.

FIG. 7 is a perspective in-use view of an embodiment of the disclosure.

### DETAILED DESCRIPTION OF THE INVENTION

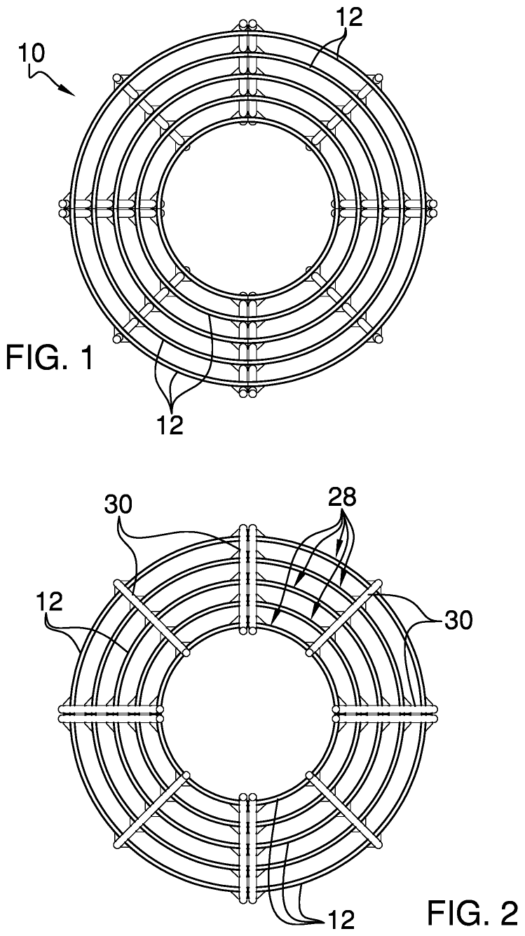

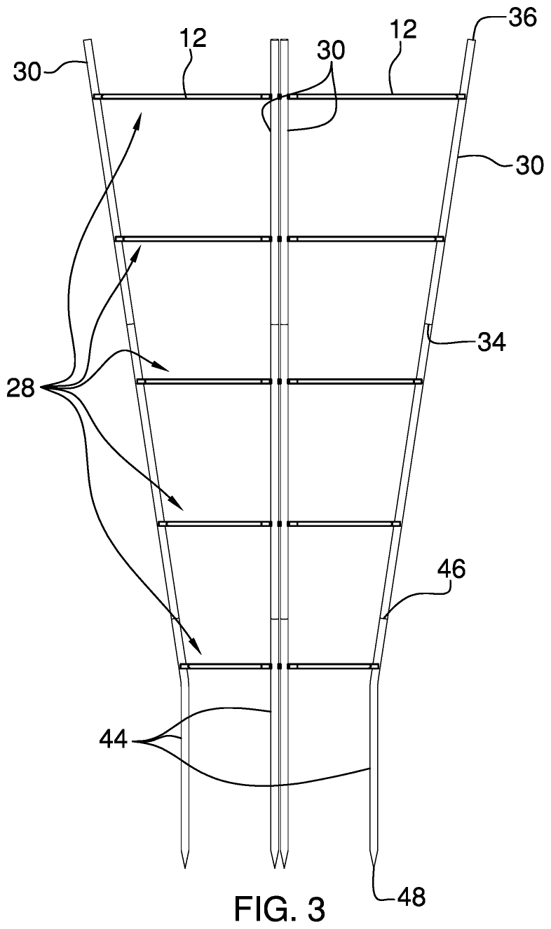

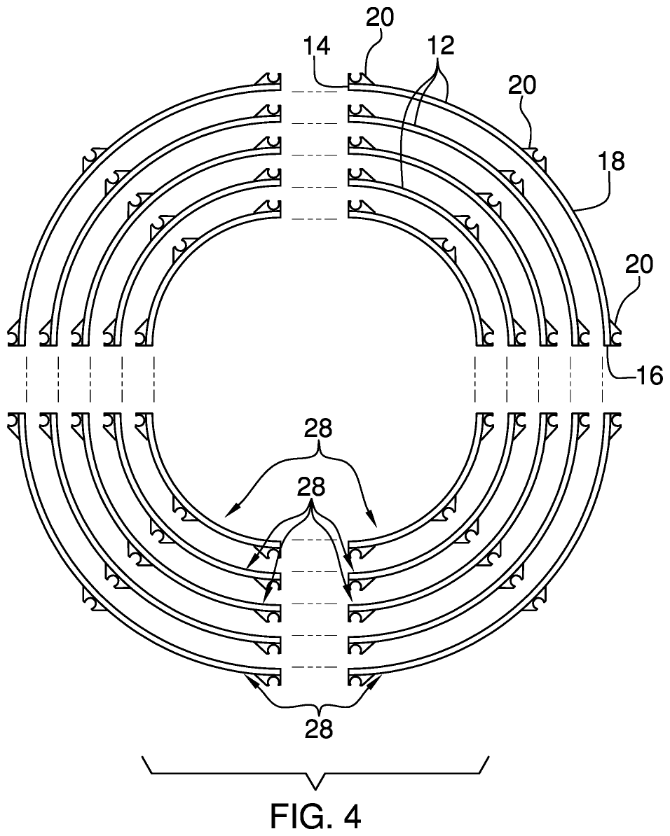

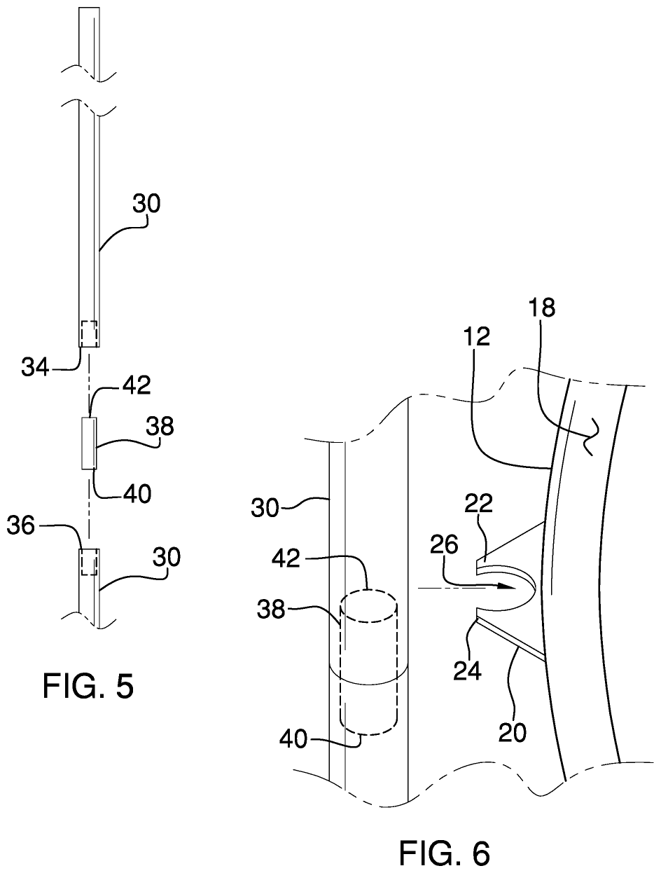

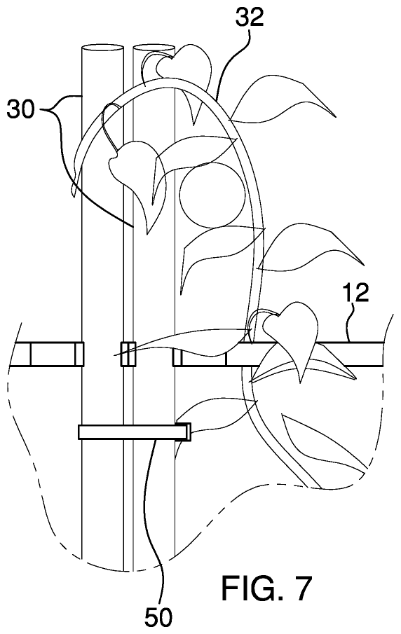

With reference now to the drawings, and in particular to FIGS. 1 through 7 thereof, a new modular cage device embodying the principles and concepts of an embodiment of the disclosure and generally designated by the reference numeral 10 will be described.

As best illustrated in FIGS. 1 through 7, the modular plant cage assembly 10 generally comprises a plurality of horizontal members 12 that is each curved along a longitudinal axis such that each of the horizontal members 12 defines an arc of a circular segment. Each of the horizontal members 12 has a first end 14, a second end 16 and an outer surface 18 extending therebetween, and each of the horizontal members 12 is curved between the first 14 and second 16 ends. Each of the horizontal members 12 includes a plurality of clips 20 that is each coupled to the outer surface 18. The clips 20 on each of the horizontal members 12 are spaced apart from each other and are distributed between the first 14 and second 16 ends, and each of the clips 20 is oriented to face outwardly from the arc defined by the horizontal support 12. Moreover, each of the clips 20 has a first portion 22 that is spaced from a second portion 24 to define a clipping space 26 between the first 22 and second 24 portions. The clipping space 26 in each of the clips 20 is concavely arcuate between the first 22 and second 24 portions.

The plurality of horizontal members 12 includes a plurality of sets of the horizontal members 28. Each of the sets of horizontal members 28 has a unique length with respect to each other ranging between a minimum length and a maximum length. The minimum length may be approximately 12.0 inches and the maximum length may be approximately 24.0 inches.

A plurality of vertical supports 30 is provided and each of the vertical supports 30 is removably coupled between the horizontal members 12. In this way each of the vertical 30 and horizontal 12 supports forms a cage for positioning around a plant 32 growing in the ground. The plant 32 may be a tomato plant or other plant 32 that needs to be supported during maturity. The vertical supports 30 are stackable in a vertical orientation for adjusting a height of the cage thereby facilitating the cage to accommodate all growth stages of the plant 32. Each of the vertical supports 30 has a bottom end 34 and a top end 36, and each of the bottom 34 and top 36 ends of each of the vertical supports 30 is open. Each of the vertical supports 30 is positioned in the clipping space 26 in a respective one of the clips 20 for retaining the vertical supports 30 on the horizontal members 12. Thus, the first 22 and second 24 portions of the respective clip 20 frictionally engage the vertical support 30 to retain the vertical support 30 in the clipping space 26.

A plurality of plugs 38 is provided and each of the plugs 38 has a first end 40 and a second end 42. The first end 40 of each of the plugs 38 is insertable into the top end 36 of a respective one of the vertical supports 30. The second end 42 of each of the plugs 38 is insertable into the bottom end 34 of a respective one of the vertical supports 30 for coupling the respective vertical supports 30 together. The sets of horizontal members 28 are vertically arranged on the vertical supports 30 from shortest to longest. Thus, the sets of horizontal members 28 form a sequence of concentric circles being distributed vertically along the cage such that the cage has an increasing diameter from bottom to top. Additionally, each of the vertical supports 30 may have a length of approximately 36.0 inches such that the cage may have an overall height of approximately 72.0 inches.

A plurality of stakes 44 is provided and each of the stakes 44 is releasably coupled to the horizontal members 12 that are positioned at the bottom of the cage. Each of the stakes 44 has an upper end 46 and a lower end 48, and the upper end 46 of each of the stakes 44 is open. The upper end 46 of each of the stakes 44 insertably receives the first end 14 of a respective one of the plugs 38 in a lowermost set of the vertical supports 30 with respect to the cage. Additionally, the lower end 48 of each of the stakes 44 tapers to a point for penetrating the ground.

A plurality of couplers 50 is provided and each of the couplers 50 is coupled around a respective pair of vertical supports 30 that is each positioned adjacent to a respective first 14 and second 16 end of the horizontal members 12. Thus, each of the sets of horizontal members 28 is aligned with each other and retained together to form the concentric circles. Each of the couplers 50 may comprise a band or the like that is positioned around the pair of vertical supports 30.

In use, the vertical supports 30 are positioned in the clips 20 of each of the horizontal members 12. The horizontal members 12 are spaced apart from each other and are distributed along the vertical support from shortest to longest between the bottom and top end 36s of the vertical supports 30. The couplers 50 are coupled around the respective pair of vertical supports 30 thereby forming the cage. The stakes 44 are positioned on the bottom end 34 of the vertical supports 30 and the stakes 44 are driven into the ground such that the cage surrounds the plant 32. Additional vertical supports 30 can be coupled to the vertical supports 30 of the cage to increase the height of the cage. Additionally, additional sets of the horizontal members 28 are coupled to the vertical supports 30 that were added to increased height. Thus, the height of the cage can be increased to continually surround the plant 32 as the plant 32 grows.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A modular plant cage assembly being configured to surround a plant during all stages of growth, said assembly comprising:
a plurality of horizontal members, each of said horizontal members being curved along a longitudinal axis such that each of said horizontal members defines an arc of a circular segment;
a plurality of vertical supports, each of said vertical supports being removably coupled between said horizontal members such that each of said vertical and horizontal members forms a cage for positioning around a plant growing in the ground, said vertical supports being stackable in a vertical orientation for adjusting a height of said cage wherein said cage is configured to accommodate all growth stages of the plant;
a plurality of stakes, each of said stakes being releasably coupled to one of said horizontal members being positioned at the bottom of said cage, each of said stakes penetrating ground such that said cage is spaced above the ground.

2. The assembly according to claim 1, wherein:
each of said horizontal members has a first end, a second end and an outer surface extending therebetween, each of said horizontal members including a plurality of clips each being coupled to said outer surface, said clips on each of said horizontal members being spaced apart from each other and being distributed between said first and second ends, each of said clips being oriented to face outwardly from said arc defined by said horizontal support; and
each of said clips has a first portion being spaced from a second portion to define a clipping space between said first and second portions.

3. The assembly according to claim 2, wherein said plurality of horizontal members includes a plurality of sets of said horizontal members, each of said sets of horizontal members having a unique length with respect to each other ranging between a minimum length and a maximum length.

4. The assembly according to claim 2, wherein each of said vertical supports has a bottom end and a top end, each of said bottom and top ends of each of said vertical supports being open, each of said vertical supports being positioned in said clipping space in a respective one of said clips for retaining said vertical supports on said horizontal members.

5. The assembly according to claim 4, further comprising a plurality of plugs, each of said plugs having a first end and a second end, said first end of each of said plugs being insertable into said top end of a respective one of said vertical supports, said second end of each of said plugs being insertable into said bottom end of a respective one of said vertical supports for coupling said respective vertical supports together.

6. The assembly according to claim 5, wherein each of said stakes has an upper end and a lower end, said upper end of each of said stakes being open, said upper end of each of said stakes insertably receiving said first end of a respective one of said plugs in a lowermost set of said vertical supports with respect to said cage, said lower end of each of said stakes tapering to a point to penetrating the ground.

7. A modular plant cage assembly being configured to surround a plant during all stages of growth, said assembly comprising:
a plurality of horizontal members, each of said horizontal members being curved along a longitudinal axis such that each of said horizontal members defines an arc of a circular segment, each of said horizontal members having a first end, a second end and an outer surface extending therebetween, each of said horizontal members including a plurality of clips each being coupled to said outer surface, said clips on each of said horizontal members being spaced apart from each other and being distributed between said first and second ends, each of said clips being oriented to face outwardly from said arc defined by said horizontal support, each of said clips having a first portion being spaced from a second portion to define a clipping space between said first and second portions, said plurality of horizontal members including a plurality of sets of said horizontal members, each of said sets of horizontal members having a unique length with respect to each other ranging between a minimum length and a maximum length;
a plurality of vertical supports, each of said vertical supports being removably coupled between said horizontal members such that each of said vertical and horizontal members forms a cage for positioning around a plant growing in the ground, said vertical supports being stackable in a vertical orientation for adjusting a height of said cage wherein said cage is configured to accommodate all growth stages of the plant, each of said vertical supports having a bottom end and a top end, each of said bottom and top ends of each of said vertical supports being open, each of said vertical supports being positioned in said clipping space in a respective one of said clips for retaining said vertical supports on said horizontal members;
a plurality of plugs, each of said plugs having a first end and a second end, said first end of each of said plugs being insertable into said top end of a respective one of said vertical supports, said second end of each of said plugs being insertable into said bottom end of a respective one of said vertical supports for coupling said respective vertical supports together; and
a plurality of stakes, each of said stakes being releasably coupled to one of said horizontal members being positioned at the bottom of said cage, each of said stakes penetrating ground such that said cage is spaced above the ground, each of said stakes having an upper end and a lower end, said upper end of each of said stakes being open, said upper end of each of said stakes insertably receiving said first end of a respective one of said plugs in a lowermost set of said vertical supports with respect to said cage, said lower end of each of said stakes tapering to a point to penetrating the ground.
